(19) United States
(12) Patent Application Publication
(10) Pub. No.: US 2026/0340727 A1
(43) Pub. Date: Oct. 29, 2026

(54) SYSTEM AND METHOD FOR NEXT GENERATION ADVISOR PAIRING

(71) Applicant: Wells Fargo Bank, N.A., San Francisco, CA (US)

(72) Inventors: Carrie Anne Hanson, Charlotte, NC (US); Panayiotis Andrew Harakas, Charlotte, NC (US); Emily E. Ingham, Waxhaw, NC (US)

(21) Appl. No.: 18/065,826

(22) Filed: Dec. 14, 2022

(51) Int. Cl. G06Q 40/06

(52) U.S. Cl. CPC G06Q 40/06

(57) ABSTRACT

Various examples are directed to computer-implemented systems and methods for next generation advisor pairing. A method includes receiving a next generation input indicating interests of a next generation user of financial services, and receiving a plurality of candidate financial advisor inputs indicating interests and capabilities of candidate financial advisors. Candidate financial advisor match scores between the next generation user and the candidate financial advisors are generated using machine learning based on the next generation input and the plurality of candidate financial advisor inputs. A plurality of legacy financial advisor inputs related to a legacy advisor are received, and inter-advisor match scores between the legacy advisor and the candidate financial advisors are generated. Aggregate match scores are generated based on corresponding candidate financial advisor match scores and inter-advisor match scores, and the legacy advisor is notified of a selected candidate financial advisor for the next generation user.

### TECHNICAL FIELD

This document relates generally to computer systems and more particularly to systems and methods for next generation advisor pairing.

### BACKGROUND

Customers may rely on financial advisors to provide trusted financial advice and the corresponding parties may develop a beneficial and trusted relationship over time. As children of these customers age, they also may require financial advice. However, these children may not seek advice from the family financial advisor for a variety of reasons (e.g., to show independence from their parents, fear that their parents' financial advisors are beholden to the parents, not to them, preference for alternative sources of information such as social media, feelings that they are being undervalued, etc.). This next generation may instead turn to alternative modes of financial guidance, such as content creators on social media or new financial advisors, particularly financial advisors who are familiar with more modern forms of investment (e.g., cryptocurrency, NFTs, etc.) or those with whom they have more demographic similarity. In doing so, this next generation loses out on the established trust and familiarity already established with the family legacy financial advisor and, further, may risk following unsound financial advice which could have negative financial repercussions.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not of limitation, in the figures of the accompanying drawings, in which:

FIG. 1A illustrates an example embodiment of a method for next generation advisor pairing, according to various embodiments;

FIG. 1B illustrates an example embodiment of a method for using a next generation advisor pairing tool, according to various embodiments;

FIG. 2 illustrates an exemplary infrastructure for use in the present subject matter, according to various embodiments;

FIG. 3 illustrates an example machine learning module for a next generation advisor pairing tool, according to various embodiments;

FIG. 4 illustrates a flowchart of a method of training a model for a next generation advisor pairing tool, according to various embodiments; and

FIG. 5 is a block diagram of a machine in the example form of a computer system within which a set of instructions may be executed, for causing the machine to perform any one or more of the methodologies discussed herein.

### DETAILED DESCRIPTION

Next generation users of financial services, such as children or young adults, may not seek out competent financial advisors but instead take unnecessary financial risks due to lack of oversight or competence. In addition, financial services institutions desire to maintain or increase their business by targeting next generation users, particularly those who are children or relatives of existing customers, to provide financial services.

The present subject matter provides systems and methods for matching the next generation of customers with a new financial advisor whose values and interests better align with the customer's values and who may operate in tandem with the family's current financial advisor. Furthermore, the system may be configured to match financial advisors with one another based on agreed-upon terms, conditions, benefits, etc. In doing so, institutions may decrease attrition of next generation customers.

An advisor matching system may be configured to match a next generation user (e.g., a child of current members of a financial institution) whose family is associated with a legacy financial advisory with an additional financial advisor. The advisor matching system may receive a next generation input indicating interests of the next generation user (e.g., sports, activities, occupations, etc.) as well as a plurality of candidate additional financial advisor inputs indicating interests of each respective financial advisor. A backend engine may use machine learning and/or artificial intelligence (AI) techniques to generate match scores between a pairing of the next generation user and a respective candidate financial advisor. The backend engine may determine one or more matching additional financial advisors that are good candidates for pairing with the next generation user based on the corresponding match scores.

Additionally, the backend engine may further generate an inter-advisor match score between candidate financial advisors and the legacy financial advisor. The backend engine may consider years of experience, interests, an inferred cost to the legacy financial advisor, an inferred benefit to the candidate financial advisor, etc., to generate the inter-advisor match score. Furthermore, the backend engine may output one or more recommended terms and/or conditions that may be established between the legacy financial advisor and the candidate financial advisor. For example, a credit split between the two parties may be recommended based on the inter-advisor match score, an inferred cost to the legacy financial advisor, an inferred benefit to the candidate financial advisor, and/or the like.

The advisor matching system may additionally be configured to generate an aggregate match score for the combination of a next-generation user (e.g., the child of current members of a financial institution), the legacy financial advisor, and a candidate financial advisor based on the corresponding match score between the next-generation user and the candidate financial advisor and the inter-advisor match score between the candidate financial advisor and the legacy financial advisor. The aggregate match score may be indicative of the predicted success for the candidate financial advisor with the next-generation user and the legacy financial advisor.

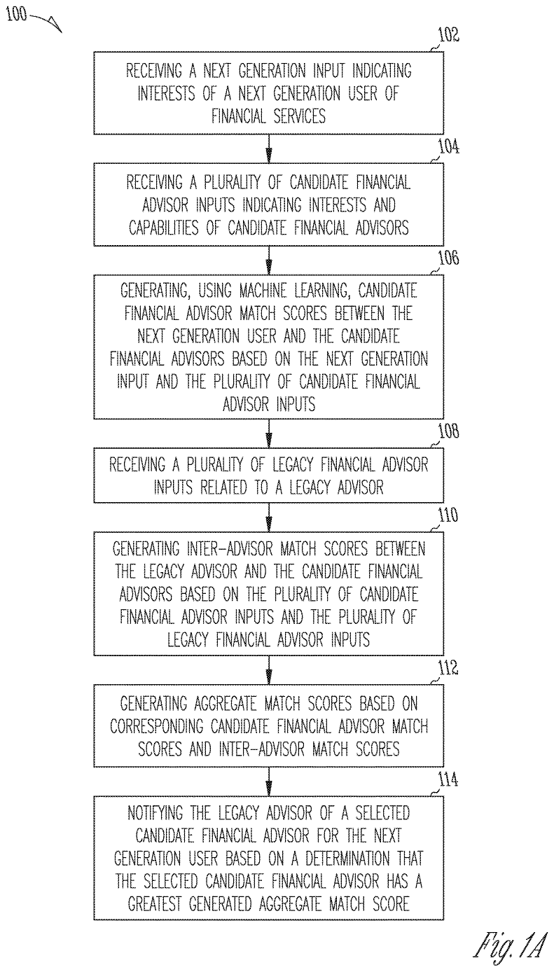

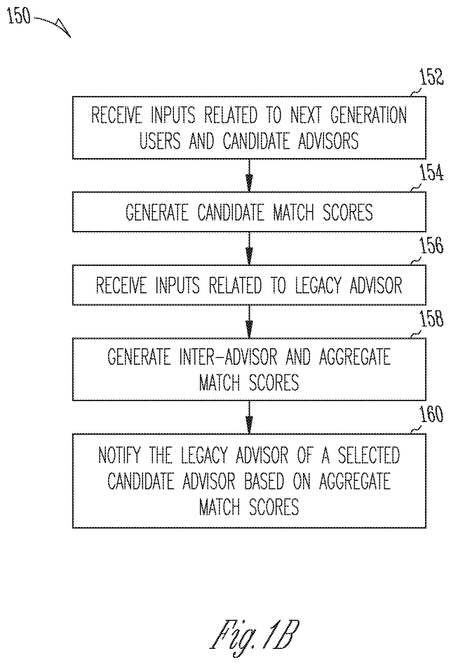

FIG. 1A illustrates an example embodiment of a method for next generation advisor pairing, according to various embodiments. The method 100 includes receiving a next generation input indicating interests of a next generation user of financial services, at step 102, and receiving a plurality of candidate financial advisor inputs indicating interests and capabilities of candidate financial advisors, at step 104. At step 106, candidate financial advisor match scores between the next generation user and the candidate financial advisors are generated using machine learning based on the next generation input and the plurality of candidate financial advisor inputs. A plurality of legacy financial advisor inputs related to a legacy advisor are received, at step 108, and inter-advisor match scores between the legacy advisor and the candidate financial advisors are generated based on the plurality of candidate financial advisor inputs and the plurality of legacy financial advisor inputs, at step 110. At step 112, aggregate match scores are generated based on corresponding candidate financial advisor match scores and inter-advisor match scores, and the legacy advisor is notified of a selected candidate financial advisor for the next generation user based on a determination that the selected candidate financial advisor has a greatest generated aggregate match score, at step 114.

According to various embodiments, the legacy advisor is a financial advisor for a parent of the next generation user. As used herein, the term “parent” refers to a parent, step-parent, legal guardian, grandparent, or any relative of the next generation user, any individual that the next generation user may inherit from, or any individual that may have a financial interest in the next generation user. The next generation input relates to one or more of activities or occupations of the next generation user of financial services, in some examples. In various examples, using machine learning includes using a machine learning model including one or more of a long short-term memory (LSTM) network, bidirectional encoder representations from transformers (BERT), natural language processing (NLP), or an artificial intelligence (AI)-based knowledge tree. Generating inter-advisor match scores between the legacy advisor and the candidate financial advisors includes using one or more of machine learning or artificial intelligence, in various embodiments. In various examples, generating aggregate match scores includes using one or more of machine learning or artificial intelligence.

According to various examples, generating inter-advisor match scores between the legacy advisor and the candidate financial advisors includes using one or more of years of experience of the candidate financial advisors, interests of the candidate financial advisors, geographic location of the legacy advisor, geographic location of the candidate financial advisors, an inferred cost to the legacy advisor, or an inferred benefit to the candidate financial advisors. The method may further include generating one or more recommended terms or conditions that may be established between the legacy advisor and the selected candidate financial advisor, in various examples. According to various embodiments, the one or more recommended terms or conditions may include a recommended credit split between the legacy advisor and the selected candidate financial advisor. The recommended credit split may be based on one or more of the inter-advisor match scores, an inferred cost to the legacy advisor, or an inferred benefit to the selected candidate financial advisor, in various examples.

In various examples, notifying the legacy advisor includes providing a customized display on a device accessible by the legacy advisor. The method may further include providing a selectable level of oversight by the legacy advisor over the selected candidate financial advisor, in various embodiments. In some embodiments, the method may include triggering notifications to a parent of next generation user or to the legacy advisor based on one or more thresholds related to the selectable level of oversight.

Various embodiments of the present subject matter relate to matching next generation users (such as children of existing clients) with new financial advisor based on interests, goals, age, gender, experience level, geographic location or other information. This matching benefits the next generation user by making sound financial advice available, and benefits a financial services provider by providing new customers. Next generation users may not have same level of investment experience, wealth, or investment opportunity as their parents. The present subject matter may link a more age-appropriate advisor to begin working with children of clients, and may like the new (next generation) advisor with the advisor of the parents, in some examples. In various examples, the present subject matter may provide some type of revenue sharing between the new advisor and the advisor of the parents, to provide incentives to the respective advisors.

The present system may provide for a match scoring system for best fit of a new advisor with the child, and provide oversight by parent account over the children account, in some examples. In some examples, the present system may provide for connecting of financial services accounts of the parent with those of the next generation user for risk mitigation or payment guarantees. For example, the system may guarantee returns within a range of what the parent account is yielding, and give the next generation user access to a better suite of investment, based on the relationship. The present system may provide for a soft hand-off of business to the next generation advisor that the next generation user is comfortable with, such that a relationship develops between the next generation advisor to guard against the next generation user leaving the advisor and taking assets to a different financial services company. In various examples, the next generation user is a young adult able to legally make financial decisions, but the present subject matter may be applied to younger users through the implementation of a custodial account.

In various embodiments, the present subject matter may provide for a customer-initiation feature that allows parents to request an advisor for their child or dependent. For example, a parent may have given money to a child and want them to be responsible with the money. In some embodiments, the present system provides for an oversight mechanism, which may escalate a financial decision for a second opinion to the parent's advisor in certain predetermined circumstances. The system may use a plurality of factors for performing an inter-advisor match score, and the parent advisor may only want to work with a next generation advisor in the same time zone, or only one that has specific certifications, and the parent advisor may indicate those factors to generate the match score, in some embodiments.

According to various embodiments, the match scores (candidate match, inter-advisor match, and aggregate match) may be generated and used to provide a ranked list of next generation advisors (with a percent match provided, for example) for selection by the parent (legacy) advisor, the parent, or the next generation user. The system may make a recommendation, a suggestion, or just provide a list of next generation advisors, in various examples. The present system may include incentives to make financial services advice attractive to the next generation user and/or the next generation advisor, in various examples. In some examples, the next generation user may direct their account themselves to an extent based on a type of financial account, while other actions may require advisor input, to provide a hybrid self-directed/advisor relationship, and providing for use of the next generation advisor as a backstop for certain transactions (such as for investments in individual stocks).

FIG. 1B illustrates an example embodiment of a method for using a next generation advisor pairing tool, according to various embodiments. According to various embodiments, the method 150 includes receiving inputs related to next generation users and candidate advisors, at step 152. The inputs may include interests of the next generation users and interests and capabilities of candidate advisors. The method 150 also includes generating candidate match scores, at step 154. The candidate match scores may be based on the received inputs, in various examples.

The method 150 continues at step 156, where inputs are received related to a legacy advisor. The inputs may include years of experience or interests of the legacy advisor,, in various examples. Inter-advisor and aggregate match scores are generated, at step 158. In various examples, the inter-advisor match score may be based on the candidate advisor inputs and the legacy advisor inputs. The aggregate match score may be based on corresponding candidate match scores and inter-advisor match scores, in various examples. At step 160, the legacy advisor is notified of a selected candidate advisor based on aggregate match scores. In various examples, the selected candidate advisor may be chosen based on a determination that the selected candidate advisor has a greatest generated aggregate match score. According to various embodiments, the calculation of one or more match scores may include using machine learning or artificial intelligence.

Various embodiments include a computing system with one or more processors and a data storage system in communication with the one or more processors, wherein the data storage system comprises instructions thereon that, when executed by the one or more processors, causes the one or more processors to execute the steps of the methods of FIGS. 1A-1B. In some examples, the machine learning may include a machine learning model including a neural network. The machine learning model may include one or more of a long short-term memory (LSTM) network, bidirectional encoder representations from transformers (BERT), natural language processing (NLP), or an artificial intelligence (AI)-based knowledge tree, in various examples. Other types of machine learning models may be used without departing from the scope of the present subject matter.

Various embodiments include a non-transitory computer-readable storage medium, the non-transitory computer-readable storage medium including instructions that, when executed by computers, cause the computers to perform operations including the methods of FIGS. 1A-1B. In various embodiments, the present system runs simulations to train the machine learning models, and to identify process improvements and optimization from simulated advisor matching. Training of the models may be accomplished online or offline, in various embodiments.

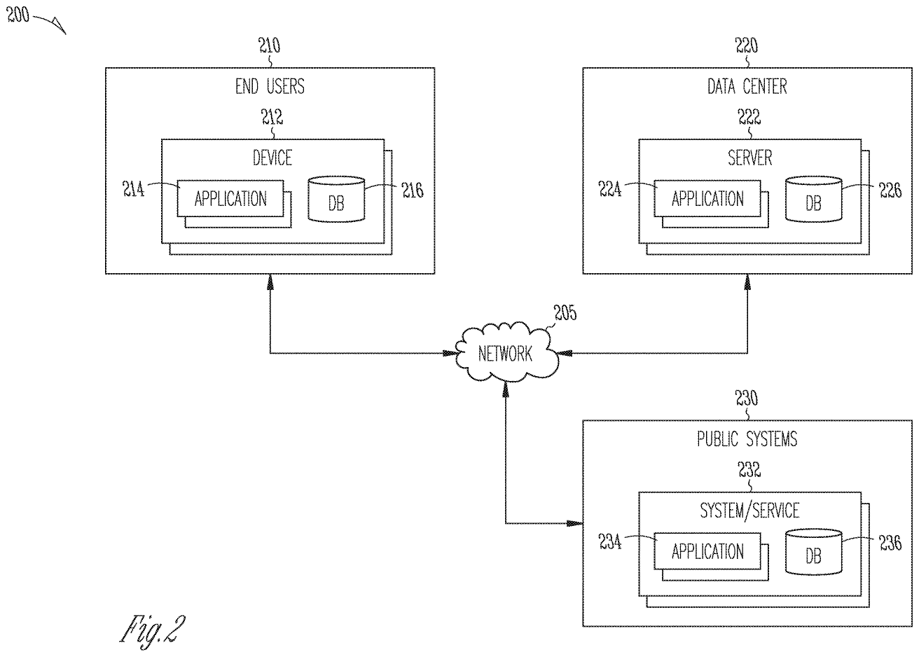

FIG. 2 illustrates an exemplary infrastructure for providing a system of the present subject matter. The infrastructure may comprise a distributed system 200 that may include a client-server architecture or cloud computing system. Distributed system 200 may have one or more end users 210. An end user 210 may have various computing devices 212, which may be a machine 500 as described below. The end-user computing devices 212 may comprise applications 214 that are either designed to execute in a stand-alone manner, or interact with other applications 214 located on the device 212 or accessible via the network 205. These devices 212 may also comprise a data store 216 that holds data locally, the data being potentially accessible by the local applications 214 or by remote applications.

The system 200 may also include one or more data centers 220. A data center 220 may be a server 222 or the like associated with a business entity that an end user 210 may interact with. The business entity may be a computer service provider, as may be the case for a cloud services provider, or it may be a consumer product or service provider, such as a retailer. The data center 220 may comprise one or more applications 224 and databases 226 that are designed to interface with the applications 214 and databases 216 of end-user devices 212. Data centers 220 may represent facilities in different geographic locations where the servers 222 may be located. Each of the servers 222 may be in the form of a machine(s) 500.

The system 200 may also include publicly available systems 230 that comprise various systems or services 232, including applications 234 and their respective databases 236. Such applications 234 may include news and other information feeds, search engines, social media applications, and the like. The systems or services 232 may be provided as comprising a machine(s) 500.

The end-user devices 212, data center servers 222, and public systems or services 232 may be configured to connect with each other via the network 205, and access to the network by machines may be made via a common connection point or different connection points, e.g., a wireless connection point and a wired connection. Any combination of common or different connections points may be present, and any combination of wired and wireless connection points may be present as well. The network 205, end users 210, data centers 220, and public systems 230 may include network hardware such as routers, switches, load balancers and/or other network devices.

Other implementations of the system 200 are also possible. For example, devices other than the client devices 212 and servers 222 shown may be included in the system 200. In an implementation, one or more additional servers may operate as a cloud infrastructure control, from which servers and/or clients of the cloud infrastructure are monitored, controlled and/or configured. For example, some or all of the techniques described herein may operate on these cloud infrastructure control servers. Alternatively, or in addition, some or all of the techniques described herein may operate on the servers 222.

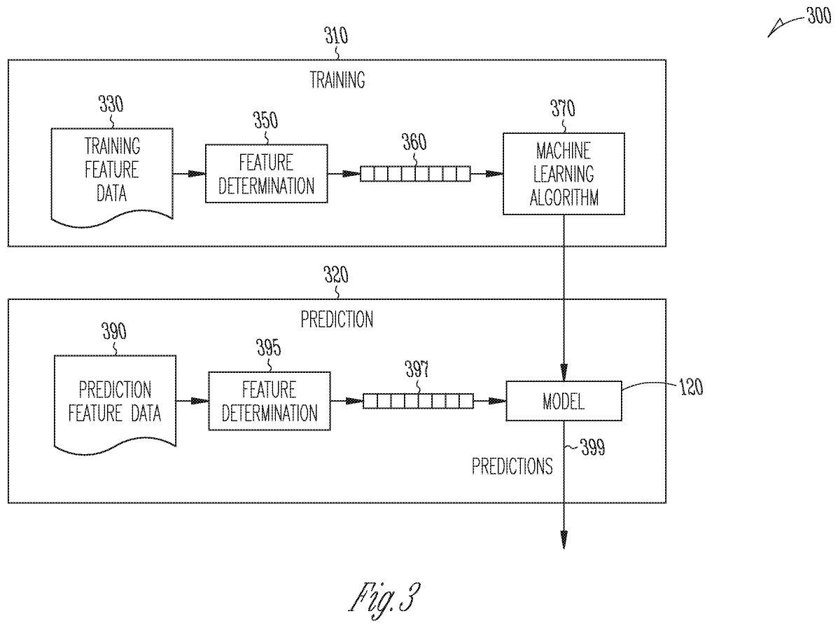

FIG. 3 shows an example machine learning module 300 according to some examples of the present disclosure. The machine learning module 300 may be implemented in whole or in part by one or more computing devices. In some examples, the training module 310 may be implemented by a different device than the prediction module 320. In these examples, the model 120 may be created on a first machine and then sent to a second machine.

Machine learning module 300 utilizes a training module 310 and a prediction module 320. Training module 310 inputs training feature data 330 into feature determination module 350. The training feature data 330 may include data determined to be predictive of identifying selected candidate financial advisors. Categories of training feature data may include user input data, social media data, other third-party data, or the like. In some examples, years of experience of the candidate financial advisors, interests of the candidate financial advisors, geographic location of the legacy advisor, geographic location of the candidate financial advisors, an inferred cost to the legacy advisor, or an inferred benefit to the candidate financial advisors. Specific training feature data and prediction feature data 390 may include, for example one or more of: interests, activities or occupations of the next generation user of financial services, and the like.

Feature determination module 350 selects training vector 360 from the training feature data 330. The selected data may fill training vector 360 and comprises a set of the training feature data that is determined to be predictive of identifying selected candidate financial advisors for a next generation user. In some examples, the tasks performed by the feature determination module 350 may be performed by the machine learning algorithm 370 as part of the learning process. Feature determination module 350 may remove one or more features that are not predictive of identifying selected candidate financial advisors to training the model 120. This may produce a more accurate model that may converge faster. Information chosen for inclusion in the training vector 360 may be all the training feature data 330 or in some examples, may be a subset of all the training feature data 330.

In other examples, the feature determination module 350 may perform one or more data standardization, cleanup, or other tasks such as encoding non numerical features. For example, for categorical feature data, the feature determination module 350 may convert these features to numbers. In some examples, encodings such as “One Hot Encoding” may be used to convert the categorical feature data to numbers. This enables a representation of the categorical variables as binary vectors and provided a “probability-like” number for each label value to give the model more expressive power. One hot encoding represents a category as a vector whereby each possible category value is represented by one element in the vector. When the data is equal to that category value, the value of the vector is a ‘1’ and all other elements are zero (or vice versa).

The training vector 360 may be utilized (along with any applicable labels) by the machine learning algorithm 370 to produce a model 120. In some examples, other data structures other than vectors may be used. The machine learning algorithm 370 may learn one or more layers of a model. Example layers may include convolutional layers, dropout layers, pooling/up sampling layers, SoftMax layers, and the like. Example models may be a neural network, where each layer is comprised of a plurality of neurons that take a plurality of inputs, weight the inputs, input the weighted inputs into an activation function to produce an output which may then be sent to another layer. Example activation functions may include a Rectified Linear Unit (ReLu), and the like. Layers of the model may be fully or partially connected. In other examples, machine learning algorithm may be a gradient boosted tree and the model may be one or more data structures that describe the resultant nodes, leaves, edges, and the like of the tree.

In the prediction module 320, prediction feature data 390 may be input to the feature determination module 395. The prediction feature data 390 may include the data described above for the training feature data, but for a specific items such as candidate financial advisors or next generation users. In some examples, the prediction module 320 may be run sequentially for one or more items. Feature determination module 395 may operate the same, or differently than feature determination module 350. In some examples, feature determination modules 350 and 395 are the same modules or different instances of the same module. Feature determination module 395 produces vector 397, which is input into the model 120 to produce predictions 399. For example, the weightings and/or network structure learned by the training module 310 may be executed on the vector 397 by applying vector 397 to a first layer of the model 120 to produce inputs to a second layer of the model 120, and so on until the prediction 399 is output. As previously noted, other data structures may be used other than a vector (e.g., a matrix).

The training module 310 may operate in an offline manner to train the model 120. The prediction module 320, however, may be designed to operate in an online manner. It should be noted that the model 120 may be periodically updated via additional training and/or user feedback. For example, additional training feature data 330 may be collected. The feedback, along with the prediction feature data 390 corresponding to that feedback, may be used to refine the model by the training module 310.

In some example embodiments, results obtained by the model 120 during operation (e.g., outputs produced by the model in response to inputs) are used to improve the training data, which is then used to generate a newer version of the model. Thus, a feedback loop is formed to use the results obtained by the model to improve the model.

The machine learning algorithm 370 may be selected from among many different potential supervised or unsupervised machine learning algorithms. Examples of learning algorithms include artificial neural networks, convolutional neural networks, Bayesian networks, instance-based learning, support vector machines, decision trees (e.g., Iterative Dichotomiser 3, C4.5, Classification and Regression Tree (CART), Chi-squared Automatic Interaction Detector (CHAID), and the like), random forests, gradient boosted tree, linear classifiers, quadratic classifiers, k-nearest neighbor, linear regression, logistic regression, a region based CNN, a full CNN (for semantic segmentation), a mask R-CNN algorithm for instance segmentation, and hidden Markov models. Examples of unsupervised learning algorithms include expectation-maximization algorithms, vector quantization, and information bottleneck method.

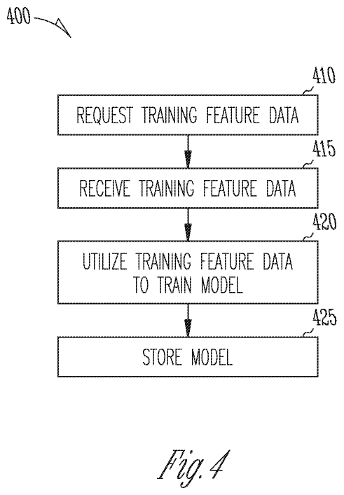

FIG. 4 illustrates a flowchart of a method 400 of training a model for a next generation advisor pairing tool, according to various embodiments. At operation 410 the training module (e.g., training module 310 as implemented by a model system) may request training feature data, from one or more systems. At operation 415 the training module may receive the training feature data. The training feature data may be processed using more data standardization, cleanup, or other tasks such as encoding non numerical features (e.g., one hot encoding). At operation 420, the training model may use the training feature data to train the model. For example, by creating a gradient boosted tree, neural network, or the like. At operation 425 the model may be stored in a storage device. In some examples in which the training operations and predictions are done on separate computing devices, the model may be transmitted to a computing device doing predictions.

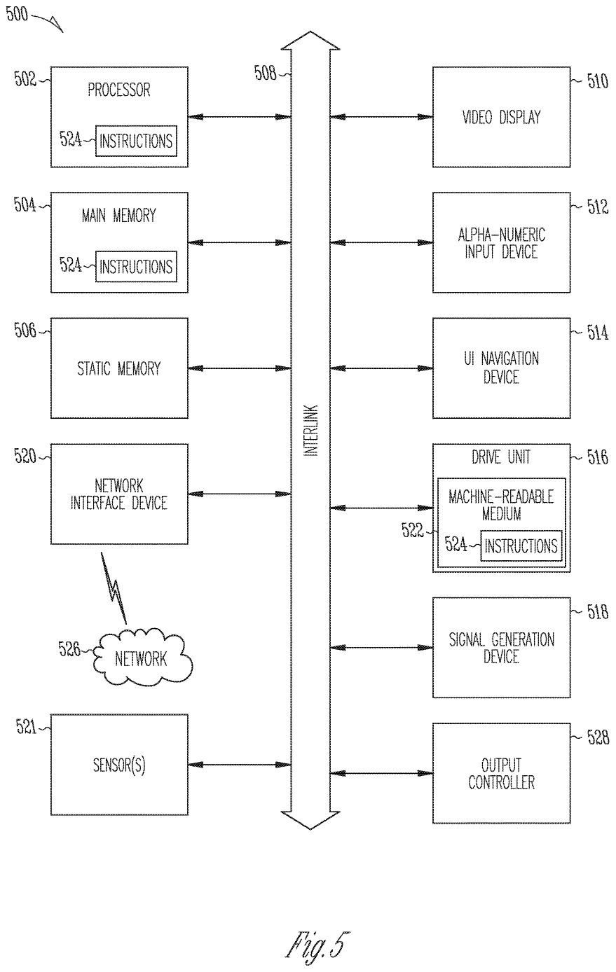

FIG. 5 illustrates a block diagram of an example machine 500 upon which any one or more of the techniques (e.g., methodologies) discussed herein may perform. In alternative embodiments, the machine 500 may operate as a standalone device or may be connected (e.g., networked) to other machines. In a networked deployment, the machine 500 may operate in the capacity of a server machine, a client machine, or both in server-client network environments. In an example, the machine 500 may act as a peer machine in peer-to-peer (P2P) (or other distributed) network environment. The machine 500 may implement one or more of the training and prediction modules 310, 320 (e.g., as software or dedicated hardware) and may be configured to perform the methods of FIGS. 1A, 1B and 4. The machine 500 may be in the form of a personal computer (PC), a tablet PC, a set-top box (STB), a personal digital assistant (PDA), a mobile telephone, a smart phone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Machine (e.g., computer system) 500 may include a hardware processor 502 (e.g., a central processing unit (CPU), a graphics processing unit (GPU), a hardware processor core, or any combination thereof), a main memory 504 and a static memory 506, some or all of which may communicate with each other via an interlink (e.g., bus) 508. The machine 500 may further include a display unit 510, an alphanumeric input device 512 (e.g., a keyboard), and a user interface (UI) navigation device 514 (e.g., a mouse). In an example, the display unit 510, input device 512 and UI navigation device 514 may be a touch screen display. The machine 500 may additionally include a storage device (e.g., drive unit) 516, a signal generation device 518 (e.g., a speaker), a network interface device 520, and one or more sensors 521, such as a global positioning system (GPS) sensor, compass, accelerometer, or other sensor. The machine 500 may include an output controller 528, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 516 may include a machine readable medium 522 on which is stored one or more sets of data structures or instructions 524 (e.g., software) embodying or utilized by any one or more of the techniques or functions described herein. The instructions 524 may also reside, completely or at least partially, within the main memory 504, within static memory 506, or within the hardware processor 502 during execution thereof by the machine 500. In an example, one or any combination of the hardware processor 502, the main memory 504, the static memory 506, or the storage device 516 may constitute machine readable media.

While the machine readable medium 522 is illustrated as a single medium, the term “machine readable medium” may include a single medium or multiple media (e.g., a centralized or distributed database, and/or associated caches and servers) configured to store the one or more instructions 524.

The term “machine readable medium” may include any medium that is capable of storing, encoding, or carrying instructions for execution by the machine 500 and that cause the machine 500 to perform any one or more of the techniques of the present disclosure, or that is capable of storing, encoding or carrying data structures used by or associated with such instructions. Non-limiting machine-readable medium examples may include solid-state memories, and optical and magnetic media. Specific examples of machine-readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); Solid State Drives (SSD); and CD-ROM and DVD-ROM disks. In some examples, machine readable media may include non-transitory machine-readable media. In some examples, machine readable media may include machine readable media that is not a transitory propagating signal.

The instructions 524 may further be transmitted or received over a communications network 526 using a transmission medium via the network interface device 520. The Machine 500 may communicate with one or more other machines utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others. In an example, the network interface device 520 may include one or more physical jacks (e.g., Ethernet, coaxial, or phone jacks) or one or more antennas to connect to the communications network 526. In an example, the network interface device 520 may include a plurality of antennas to wirelessly communicate using at least one of single-input multiple-output (SIMO), multiple-input multiple-output (MIMO), or multiple-input single-output (MISO) techniques. In some examples, the network interface device 520 may wirelessly communicate using Multiple User MIMO techniques.

### Other Notes and Examples

Example 1 is a computer-implemented method including receiving, by a computer system, a next generation input indicating interests of a next generation user of financial services, receiving, by the computer system, a plurality of candidate financial advisor inputs indicating interests and capabilities of candidate financial advisors, generating, by the computer system using machine learning, candidate financial advisor match scores between the next generation user and the candidate financial advisors based on the next generation input and the plurality of candidate financial advisor inputs, receiving, by the computer system, a plurality of legacy financial advisor inputs related to a legacy advisor, generating, by the computer system, inter-advisor match scores between the legacy advisor and the candidate financial advisors based on the plurality of candidate financial advisor inputs and the plurality of legacy financial advisor inputs, generating, by the computer system, aggregate match scores based on corresponding candidate financial advisor match scores and inter-advisor match scores, and notifying, by the computer system, the legacy advisor of a selected candidate financial advisor for the next generation user based on a determination that the selected candidate financial advisor has a greatest generated aggregate match score.

In Example 2, the subject matter of Example 1 optionally includes wherein the legacy advisor is a financial advisor for a parent of the next generation user.

In Example 3, the subject matter of Example 1 optionally includes wherein the next generation input relates to one or more of activities or occupations of the next generation user of financial services.

In Example 4, the subject matter of Example 1 optionally includes wherein using machine learning includes using a machine learning model including one or more of a long short-term memory (LSTM) network, bidirectional encoder representations from transformers (BERT), natural language processing (NLP), or an artificial intelligence (AI)-based knowledge tree.

In Example 5, the subject matter of Example 1 optionally includes wherein generating inter-advisor match scores between the legacy advisor and the candidate financial advisors includes using one or more of machine learning or artificial intelligence.

In Example 6, the subject matter of Example 1 optionally includes wherein generating aggregate match scores includes using one or more of machine learning or artificial intelligence.

In Example 7, the subject matter of Example 1 optionally includes wherein generating inter-advisor match scores between the legacy advisor and the candidate financial advisors includes using one or more of years of experience of the candidate financial advisors, interests of the candidate financial advisors, geographic location of the legacy advisor, geographic location of the candidate financial advisors, or an inferred benefit to the candidate financial advisors.

In Example 8, the subject matter of Example 1 optionally further includes generating, by the computer system, one or more recommended terms or conditions that may be established between the legacy advisor and the selected candidate financial advisor.

In Example 9, the subject matter of Example 8 optionally includes wherein the one or more recommended terms or conditions include a recommended credit split between the legacy advisor and the selected candidate financial advisor.

In Example 10, the subject matter of Example 9 optionally includes wherein the recommended credit split is based on one or more of the inter-advisor match scores or an inferred benefit to the selected candidate financial advisor.

Example 11 is a system including: a computing system comprising one or more processors and a data storage system in communication with the one or more processors, wherein the data storage system comprises instructions thereon that, when executed by the one or more processors, causes the one or more processors to: receive a next generation input indicating interests of a next generation user of financial services; receive a plurality of candidate financial advisor inputs indicating interests and capabilities of candidate financial advisors; generate, using machine learning, candidate financial advisor match scores between the next generation user and the candidate financial advisors based on the next generation input and the plurality of candidate financial advisor inputs; receive a plurality of legacy financial advisor inputs related to a legacy advisor; generate inter-advisor match scores between the legacy advisor and the candidate financial advisors based on the plurality of candidate financial advisor inputs and the plurality of legacy financial advisor inputs; generate aggregate match scores based on corresponding candidate financial advisor match scores and inter-advisor match scores; and notify the legacy advisor of a selected candidate financial advisor for the next generation user based on a determination that the selected candidate financial advisor has a greatest generated aggregate match score.

In Example 12, the subject matter of Example 11 optionally includes wherein the next generation input relates to one or more of activities or occupations of the next generation user of financial services.

In Example 13, the subject matter of Example 11 optionally includes wherein the data storage system comprises instructions thereon that, when executed by the one or more processors, causes the one or more processors to: generate one or more recommended terms or conditions that may be established between the legacy advisor and the selected candidate financial advisor.

In Example 14, the subject matter of Example 13 optionally includes wherein the one or more recommended terms or conditions include a recommended credit split between the legacy advisor and the selected candidate financial advisor.

In Example 15, the subject matter of Example 14 optionally includes wherein the recommended credit split is based on one or more of the inter-advisor match scores or an inferred benefit to the selected candidate financial advisor.

Example 16 is a non-transitory computer-readable storage medium, the non-transitory computer-readable storage medium including instructions that, when executed by computers, cause the computers to perform operations of: receiving a next generation input indicating interests of a next generation user of financial services; receiving a plurality of candidate financial advisor inputs indicating interests and capabilities of candidate financial advisors; generating, using machine learning, candidate financial advisor match scores between the next generation user and the candidate financial advisors based on the next generation input and the plurality of candidate financial advisor inputs; receiving a plurality of legacy financial advisor inputs related to a legacy advisor; generating inter-advisor match scores between the legacy advisor and the candidate financial advisors based on the plurality of candidate financial advisor inputs and the plurality of legacy financial advisor inputs; generating aggregate match scores based on corresponding candidate financial advisor match scores and inter-advisor match scores; and notifying the legacy advisor of a selected candidate financial advisor for the next generation user based on a determination that the selected candidate financial advisor has a greatest generated aggregate match score.

In Example 17, the subject matter of Example 16 optionally includes wherein notifying the legacy advisor includes providing a customized display on a device accessible by the legacy advisor.

In Example 18, the subject matter of Example 16 optionally includes wherein the non-transitory computer-readable storage medium further includes instructions that, when executed by computers, cause the computers to perform operations of: providing a selectable level of oversight by the legacy advisor over the selected candidate financial advisor.

In Example 19, the subject matter of Example 18 optionally includes wherein the non-transitory computer-readable storage medium further includes instructions that, when executed by computers, cause the computers to perform operations of: triggering notifications to a parent of next generation user or to the legacy advisor based on one or more thresholds related to the selectable level of oversight.

In Example 20, the subject matter of Example 16 optionally includes wherein generating aggregate match scores includes using one or more of machine learning or artificial intelligence.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure, for example, to comply with 37 C.F.R. § 1.72(b) in the United States of America. It is submitted with the understanding that it will not be used to interpret or limit the scope or meaning of the claims.

Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

1. A computer-implemented method comprising:
receiving, by a computer system, a next generation input indicating interests of a next generation user of financial services, wherein the next generation user is a child or young adult relative of an existing client of a financial services provider;
receiving, by the computer system, a plurality of candidate financial advisor inputs indicating interests and capabilities of a plurality of candidate financial advisors for the next generation user;
generating, by the computer system using machine learning, candidate financial advisor match scores between the next generation user and the plurality of candidate financial advisors based on the next generation input and the plurality of candidate financial advisor inputs, wherein the machine learning comprises training a model using historical data of advisor-client pairings to identify patterns and features that contribute to matches, and applying the trained model to the received inputs to generate the match scores;
receiving, by the computer system, a plurality of legacy financial advisor inputs related to a legacy advisor, wherein the legacy advisor is a financial advisor for the existing client;
generating, by the computer system, inter-advisor match scores between the legacy advisor and the plurality of candidate financial advisors based on the plurality of candidate financial advisor inputs and the plurality of legacy financial advisor inputs;
generating, by the computer system, aggregate match scores based on corresponding candidate financial advisor match scores and inter-advisor match scores;
selecting, by the computer system, a candidate financial advisor of the plurality of candidate financial advisors having a greatest generated aggregate match score;
notifying, by the computer system, the legacy advisor of the selected candidate financial advisor for the next generation user by providing a customized display on a device accessible by the legacy advisor; and
connecting, by the computer system, a financial services account of the existing client with a financial services account of the next generation user for risk mitigation, wherein connecting the financial services accounts comprises providing returns on the financial services account of the next generation user within a range of returns yielded by the financial services account of the existing client.

2. The computer-implemented method of claim 1, wherein the legacy advisor is a financial advisor for a parent of the next generation user.

3. The computer-implemented method of claim 1, wherein the next generation input relates to one or more of activities or occupations of the next generation user of financial services.

4. The computer-implemented method of claim 1, wherein using machine learning includes using a machine learning model including one or more of a long short-term memory (LSTM) network, bidirectional encoder representations from transformers (BERT), natural language processing (NLP), or an artificial intelligence (AI)-based knowledge tree.

5. The computer-implemented method of claim 1, wherein generating inter-advisor match scores between the legacy advisor and the candidate financial advisors includes using one or more of machine learning or artificial intelligence.

6. The computer-implemented method of claim 1, wherein generating aggregate match scores includes using one or more of machine learning or artificial intelligence.

7. The computer-implemented method of claim 1, wherein generating inter-advisor match scores between the legacy advisor and the candidate financial advisors includes using one or more of years of experience of the candidate financial advisors, interests of the candidate financial advisors, geographic location of the legacy advisor, geographic location of the candidate financial advisors, or an inferred benefit to the candidate financial advisors.

8. The computer-implemented method of claim 1, further comprising:
generating, by the computer system, one or more recommended terms or conditions that may be established between the legacy advisor and the selected candidate financial advisor.

9. The computer-implemented method of claim 8, wherein the one or more recommended terms or conditions include a recommended credit split between the legacy advisor and the selected candidate financial advisor.

10. The computer-implemented method of claim 9, wherein the recommended credit split is based on one or more of the inter-advisor match scores or an inferred benefit to the selected candidate financial advisor.

11. A system comprising:
a computing system comprising one or more processors and a data storage system in communication with the one or more processors, wherein the data storage system comprises instructions thereon that, when executed by the one or more processors, causes the one or more processors to:
receive a next generation input indicating interests of a next generation user of financial services, wherein the next generation user is a child or young adult relative of an existing client of a financial services provider;
receive a plurality of candidate financial advisor inputs indicating interests and capabilities of a plurality of candidate financial advisors for the next generation user;
generate, using machine learning, candidate financial advisor match scores between the next generation user and the plurality of candidate financial advisors based on the next generation input and the plurality of candidate financial advisor inputs, wherein the machine learning comprises training a model using historical data of advisor-client pairings to identify patterns and features that contribute to matches, and applying the trained model to the received inputs to generate the match scores;
receive a plurality of legacy financial advisor inputs related to a legacy advisor, wherein the legacy advisor is a financial advisor for the existing client;
generate inter-advisor match scores between the legacy advisor and the plurality of candidate financial advisors based on the plurality of candidate financial advisor inputs and the plurality of legacy financial advisor inputs;
generate aggregate match scores based on corresponding candidate financial advisor match scores and inter-advisor match scores;
select a candidate financial advisor of the plurality of candidate financial advisors having a greatest generated aggregate match score;
notify the legacy advisor of the selected candidate financial advisor for the next generation user by providing a customized display on a device accessible by the legacy advisor; and
connect a financial services account of the existing client with a financial services account of the next generation user for risk mitigation, wherein connecting the financial services accounts comprises providing returns on the financial services account of the next generation user within a range of returns yielded by the financial services account of the existing client.

12. The system of claim 11, wherein the next generation input relates to one or more of activities or occupations of the next generation user of financial services.

13. The system of claim 11, wherein the data storage system comprises instructions thereon that, when executed by the one or more processors, causes the one or more processors to:
generate one or more recommended terms or conditions that may be established between the legacy advisor and the selected candidate financial advisor.

14. The system of claim 13, wherein the one or more recommended terms or conditions include a recommended credit split between the legacy advisor and the selected candidate financial advisor.

15. The system of claim 14, wherein the recommended credit split is based on one or more of the inter-advisor match scores or an inferred benefit to the selected candidate financial advisor.

16. A non-transitory computer-readable storage medium, the non-transitory computer-readable storage medium including instructions that, when executed by computers, cause the computers to perform operations of;
receiving a next generation input indicating interests of a next generation user of financial services, wherein the next generation user is a child or young adult relative of an existing client of a financial services provider,
receiving a plurality of candidate financial advisor inputs indicating interests and capabilities of a plurality of candidate financial advisors for the next generation user;
generating, using machine learning, candidate financial advisor match scores between the next generation user and the plurality of candidate financial advisors based on the next generation input and the plurality of candidate financial advisor inputs, wherein the machine learning comprises training a model using historical data of advisor-client pairings to identify patterns and features that contribute to matches, and applying the trained model to the received inputs to generate the match scores;
receiving a plurality of legacy financial advisor inputs related to a legacy advisor, wherein the legacy advisor is a financial advisor for the existing client;
generating inter-advisor match scores between the legacy advisor and the plurality of candidate financial advisors based on the plurality of candidate financial advisor inputs and the plurality of legacy financial advisor inputs;
generating aggregate match scores based on corresponding candidate financial advisor match scores and inter-advisor match scores;
selecting a candidate financial advisor of the plurality of candidate financial advisors having a greatest generated aggregate match score;
notifying the legacy advisor of the selected candidate financial advisor for the next generation user by providing a customized display on a device accessible by the legacy advisor; and
connecting a financial services account of the existing client with a financial services account of the next generation user for risk mitigation, wherein connecting the financial services accounts comprises providing returns on the financial services account of the next generation user within a range of returns yielded by the financial services account of the existing client.

17. The non-transitory computer-readable storage medium of claim 16, wherein notifying the legacy advisor includes providing a customized display on a device accessible by the legacy advisor,

18. The non-transitory computer-readable storage medium of claim 16, wherein the non-transitory computer-readable storage medium further includes instructions that, when executed by computers, cause the computers to perform operations of:
providing a selectable level of oversight by the legacy advisor over the selected candidate financial advisor.

19. The non-transitory computer-readable storage medium of claim 18, wherein the non-transitory computer-readable storage medium further includes instructions that, when executed by computers, cause the computers to perform operations of:
triggering notifications to a parent of next generation user or to the legacy advisor based on one or more thresholds related to the selectable level of oversight.

20. The non-transitory computer-readable storage medium of claim 16, wherein generating aggregate match scores includes using one or more of machine learning or artificial intelligence.
